(19) United States
(12) Patent Application Publication
(10) Pub. No.: US 2025/0239201 A1
(43) Pub. Date: Jul. 24, 2025

(54) DISPLAY DEVICE AND METHOD OF DRIVING A DISPLAY DEVICE

(71) Applicant: Samsung Display Co., Ltd., Yongin-Si (KR)

(72) Inventor: SUMIN YANG, Yongin-si (KR)

(21) Appl. No.: 18/959,660

(22) Filed: Nov. 26, 2024

(30) Foreign Application Priority Data
Jan. 22, 2024 (KR) 10-2024-0009702

(51) Int. Cl. G09G 3/20; G09G 3/3225

(52) U.S. Cl. CPC G09G 3/2092; G09G 3/3225; G09G 2300/0842; G09G 2320/0252

(57) ABSTRACT

A display device may include a display panel including a plurality of pixels and a data driver configured to apply data voltages to the plurality of pixels based on a data signal, a sensing driver configured to receive sensing current from at least one pixel of the plurality of pixels and to output sensing data based on the sensing current, a non-volatile memory circuit configured to store the sensing data as stored sensing data and a driving controller configured to output the data signal to the data driver and to store the sensing data received from the sensing driver. The driving controller may determine a difference between the stored sensing data and the sensing data by comparing the stored sensing data with the sensing data. The non-volatile memory circuit may store the stored sensing data which is the same as the sensing data as stored compensation data.

### CROSS-REFERENCE TO RELATED APPLICATION(S)

This application claims priority under 35 USC § 119 to Korean Patent Application No. 10-2024-0009702, filed on Jan. 22, 2024, in the Korean Intellectual Property Office (KIPO), the content of which is herein incorporated by reference in its entirety.

### BACKGROUND

### 1. Field

Embodiments of the present inventive concept relate to a display device and a method of driving a display device.

### 2. Description of the Related Art

Generally, a display device includes a display panel and a panel driver. The display panel includes a plurality of gate lines, a plurality of data lines, a plurality of sensing lines and a plurality of pixels. The panel driver includes a gate driver providing a gate signal to the gate lines, a data driver providing a data voltage to the data lines, a sensing driver receiving sensing data through the sensing lines and a driving controller controlling the gate driver, the data driver and the sensing driver.

Generally, in the display device, a difference between sensing data stored in a non-volatile memory and sensing data applied to the driving controller may occur so that a dark point (or dark spot) and a dark line are displayed on the display panel.

### SUMMARY

Some embodiments provide a display device reducing a difference between sensing data stored in a non-volatile memory and sensing data applied to a driving controller.

Some embodiments provide a method of driving the display device.

According to embodiments, a display device may include a display panel including a plurality of pixels and a data driver configured to apply data voltages to the plurality of pixels based on a data signal, a sensing driver configured to receive sensing current from at least one pixel of the plurality of pixels and to output sensing data based on the sensing current, a non-volatile memory circuit configured to store the sensing data as stored sensing data and a driving controller configured to output the data signal to the data driver and to store the sensing data received from the sensing driver. The driving controller may determine a difference between the stored sensing data and the sensing data by comparing the stored sensing data with the sensing data. The non-volatile memory circuit may store the stored sensing data which is the same as the sensing data as stored compensation data.

In an embodiment, the driving controller may compare the stored sensing data with the sensing data by determining whether values obtained by subtracting the sensing data from the stored sensing data are 0.

In an embodiment, wherein the driving controller may include a sensing storage circuit configured to store the sensing data, a dummy storage circuit configured to store the stored sensing data received from the non-volatile memory circuit as dummy sensing data, a comparing circuit configured to compare the dummy sensing data with the sensing data and a header circuit configured to store a success signal and a fail signal from the comparing circuit.

In an embodiment, when a difference between the dummy sensing data and the sensing data is 0, the comparing circuit may output the success signal to the header circuit and the non-volatile memory circuit may store the stored sensing data as the stored compensation data.

In an embodiment, the pixels may include a first pixel and a second pixel. The sensing data may include first sensing data corresponding to the first pixel and second sensing data corresponding to the second pixel. The stored sensing data may include first stored sensing data corresponding to the first sensing data and second stored sensing data corresponding to the second sensing data. The dummy sensing data may include first dummy sensing data corresponding to the first stored sensing data and second dummy sensing data corresponding to the second stored sensing data. The driving controller may compare the stored sensing data with the sensing data by determining whether values obtained by subtracting the first sensing data from the first stored sensing data and values obtained by subtracting the second sensing data from the second stored sensing data are both 0.

In an embodiment, when a difference between the dummy sensing data and the sensing data is not 0, the comparing circuit may output the fail signal to the header circuit and the dummy storage circuit may receive the stored sensing data again.

In an embodiment, when a difference between re-stored sensing data which the dummy storage circuit receives again and the sensing data is 0, the comparing circuit may output the success signal to the header circuit and the non-volatile memory circuit may store the re-stored sensing data as the stored compensation data.

In an embodiment, when the dummy storage circuit receives the stored sensing data more than or equal to a reference sensing number of times, the driving controller may output an error signal.

In an embodiment, the non-volatile memory circuit may include a first non-volatile memory circuit and a second non-volatile memory circuit. The stored sensing data may be applied to the dummy storage circuit from the first non-volatile memory circuit. When the dummy storage circuit may re-receive the stored sensing data more than or equal to a reference sensing number of times, the stored sensing data stored in the first non-volatile memory circuit may be deleted.

In an embodiment, the driving controller may further include a compensation storage circuit configured to receive the stored compensation data from the non-volatile memory circuit and a data signal output circuit configured to output the data signal. The dummy storage circuit may store dummy compensation data by receiving the stored compensation data from the non-volatile memory circuit. The comparing circuit may compare the dummy compensation data with the stored compensation data stored in the compensation storage circuit. When the dummy compensation data are consistent with the stored compensation data stored in the compensation storage circuit, the data signal output circuit may output the data signal based on the stored compensation data.

In an embodiment, when the dummy compensation data are consistent with the stored compensation data stored in the compensation storage circuit, the comparing circuit may output the success signal to the header circuit.

In an embodiment, the driving controller may further include a compensation storage circuit configured to receive the stored compensation data from the non-volatile memory circuit and a data signal output circuit configured to output the data signal. The non-volatile memory circuit may include a first non-volatile memory circuit and a second non-volatile memory circuit. The compensation storage circuit may receive the stored compensation data from the first non-volatile memory circuit. The dummy storage circuit may receive the stored compensation data from the first non-volatile memory circuit and stores the stored compensation data as dummy compensation data. The comparing circuit may compare the dummy compensation data with the stored compensation data stored in the compensation storage circuit. When the dummy compensation data are inconsistent with the stored compensation data stored in the compensation storage circuit, the dummy storage circuit and the compensation storage circuit may receive the stored compensation data again.

In an embodiment, when the dummy compensation data are inconsistent with the stored compensation data stored in the compensation storage circuit, the comparing circuit may output the fail signal to the header circuit.

In an embodiment, when the dummy storage circuit receives the stored sensing data more than or equal to a reference sensing number of times, the data signal output circuit may output the data signal based on second storage compensation data stored in the second non-volatile memory circuit.

According to embodiments, a display device may include a display panel including a plurality of pixels, a data driver configured to apply data voltages to the plurality of pixels based on a data signal, a sensing driver configured to receive sensing current from at least one pixel of the plurality of pixels and to output sensing data based on the sensing current, a non-volatile memory circuit configured to store the sensing data as stored sensing data and a driving controller configured to output the data signal to the data driver and to store the sensing data received from the sensing driver. The driving controller may include a dummy storage circuit configured to store the stored compensation data received from the non-volatile memory circuit as dummy compensation data, a compensation storage circuit configured to receive the stored compensation data from the non-volatile memory circuit and a data signal output circuit configured to output the data signal. The driving controller may output the data signal based on the stored compensation data when the stored compensation data and the dummy compensation data are same.

In embodiments, the driving controller may compare the stored sensing data with the sensing data by determining whether values obtained by subtracting the sensing data from the stored sensing data are 0.

In embodiments, when the dummy compensation data and the stored compensation data stored in the compensation storage circuit are different, the dummy storage circuit and the compensation storage circuit may receive the stored compensation data again.

In embodiments, the non-volatile memory circuit may include a first non-volatile memory circuit and a second non-volatile memory circuit. The compensation storage circuit may receive the stored compensation data from the first non-volatile memory circuit. The dummy storage circuit may store dummy compensation data which is the stored compensation data received from the first non-volatile memory circuit. When the dummy storage circuit re-receives the stored sensing data more than or equal to a reference sensing number of times, the data signal output circuit may output the data signal based on second storage compensation data stored in the second non-volatile memory circuit.

According to embodiments, a method of driving a display device may include receiving sensing data, storing the sensing data as stored sensing data in a non-volatile memory circuit, storing the sensing data as dummy sensing data in a dummy storage circuit, comparing the dummy sensing data with the stored sensing data, performing a deleting operation of the stored sensing data, a storing operation of a fail signal, and an outputting operation of an error signal when the dummy sensing data are inconsistent with the stored sensing data and storing the stored sensing data as stored compensation data in the non-volatile memory circuit when the dummy sensing data and the stored sensing data are same. Comparison between the stored sensing data and the dummy sensing data is performed by determining whether values obtained by subtracting the sensing data from the stored sensing data are 0.

In embodiments, the method may further include storing the stored compensation data as dummy compensation data in the dummy storage circuit, comparing the stored compensation data with the dummy compensation data, outputting a data signal based on previous stored compensation data, storing the fail signal and outputting the error signal when the dummy compensation data are inconsistent with the stored compensation data and outputting the data signal based on the stored compensation data when the dummy compensation data are consistent with the stored compensation data.

As described above, a display device may include a dummy storage circuit. Through the dummy storage circuit, when sensing data is stored in a non-volatile memory circuit, a difference between the sensing data receiving from a driving controller and stored sensing data stored in the non-volatile memory circuit may be determined. Accordingly, the difference between the stored sensing data and the sensing data may be reduced. Accordingly, a visibility of a dark spot and a dark line may be reduced. Additionally, a method of determining the error may be performed by determining that values obtained by subtracting sensing data from dummy sensing data are 0. Accordingly, a calculating speed may be improved and a reliability of calculating may be improved.

When the driving controller generates a data signal based on stored compensation data stored in the non-volatile memory through the dummy storage circuit, an error of the stored compensation data may be reduced. Accordingly, the visibility of the dark spot and the dark line may be further reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to an embodiment of the present inventive concept.

FIG. 2 is a circuit diagram illustrating a pixel PX of FIG. 1.

FIG. 3 is a block diagram illustrating a driving controller and a non-volatile memory circuit included in a display device of FIG. 1.

FIG. 4 is a flowchart illustrating an operation that a display device of FIG. 1 stores a stored compensation data.

FIG. 5 is a block diagram illustrating the driving controller and the non-volatile memory circuit included in the display device of FIG. 1.

FIG. 6 is a flowchart illustrating an operation of generating a data signal from a display device of FIG. 1.

FIG. 7 is a block diagram illustrating an electronic device according to an embodiment of the present inventive concept.

FIG. 8 is a diagram illustrating an example in which the electronic device of FIG. 7 is implemented as a smart phone.

### DETAILED DESCRIPTION OF THE INVENTIVE CONCEPT

Hereinafter, the present inventive concept will be explained in detail with reference to the accompanying drawings.

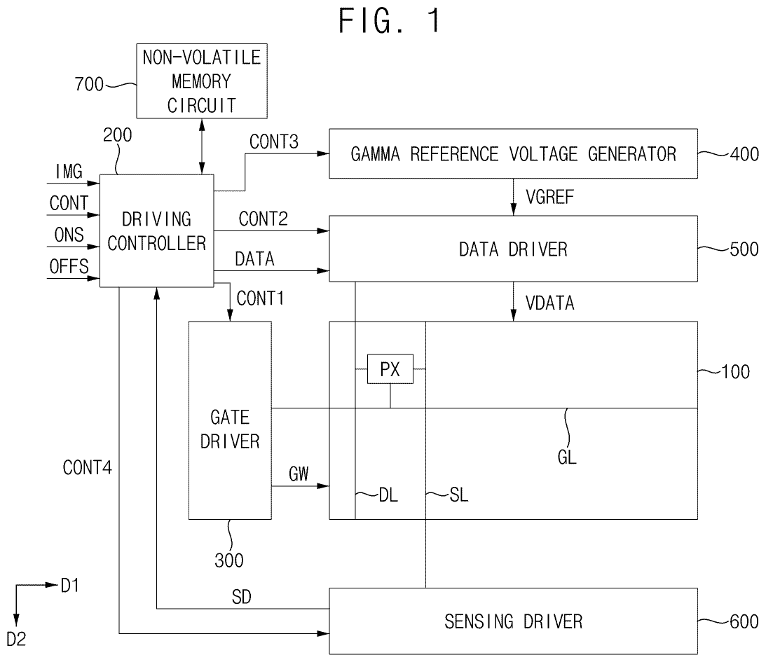

FIG. 1 is a block diagram illustrating a display device according to an embodiment of the present inventive concept.

Referring to FIG. 1, the display device may include a display panel 100 and panel driver. The panel driver may include a driving controller 200, a gate driver 300, a gamma reference voltage generator 400, a data driver 500, a sensing driver 600 and a non-volatile memory circuit 700.

The display panel 100 may have a display region on which an image is displayed and a peripheral region disposed adjacent to the display region.

The display panel 100 may include a plurality of gate lines GL, a plurality of data lines DL, a plurality of sensing lines SL and a plurality of pixels PX connected to the plurality of gate lines GL, the plurality of data lines DL and the plurality of sensing lines SL. The plurality of gate lines GL may extend in a first direction D1. The plurality of data line DL may extend in a second direction D2 crossing the first direction D1. The plurality of sensing lines SL may extend in the second direction D2.

For example, the display panel 100 may be an organic light emitting diode (OLED) display panel or a quantum dot (QD) display panel, but the present inventive concept is not limited thereto.

The driving controller 200 may receive input image data IMG and an input control signal CONT. For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on a power-on signal ONS, a power-off signal OFFS, the input image data IMG and the input control signal CONT. The panel driver may be turned-on in response to the power-on signal ONS. The panel driver may be turned-off in response to the power-off signal OFFS. For example, the display panel 100 may emit light in response to the power-on signal ONS. For example, a sensing operation may be performed to the display panel 100 in response to the power-off signal OFFS.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a scan clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG and the input control signal CONT. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the sensing driver 600 based on the input control signal CONT. The driving controller 200 may output the fourth control signal CONT4 to the sensing driver 600.

The gate driver 300 may generate gate signals for driving the plurality of gate lines GL in response to the first control signal CONT1 received from the driving controller 200. The gate driver 300 may output the gate signals to the plurality of gate lines GL.

In an embodiment of the present inventive concept, the gate driver 300 may be integrated on the peripheral region of the display panel 100. In an embodiment of the present inventive concept, the gate driver 300 may be mounted on the peripheral region of the display panel 100.

The gamma reference voltage generator 400 may generate a plurality of gamma reference voltages VGREF in response to the third control signal CONT3 received from the driving controller 200. The gamma reference voltage generator 400 may provide the plurality of gamma reference voltages VGREF to the data driver 500. The plurality of gamma reference voltage VGREF has values corresponding to the data signal DATA.

For example, the gamma reference voltage generator 400 may be disposed in the driving controller 200 or in the data driver 500.

The data driver 500 may receive the second control signal CONT2 and the data signal DATA from the driving controller 200 and receive the plurality of gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the plurality of data lines DL.

In an embodiment of the present inventive concept, the data driver 500 may be integrated on the peripheral region of the display panel 100. In an embodiment of the present inventive concept, the data driver 500 may be mounted on the peripheral region of the display panel 100.

The sensing driver 600 may control the sensing lines SL in response to the fourth control signal CONT4 received from the driving controller 200.

The sensing driver 600 may generate sensing data SD by sensing the pixels PX through the sensing lines SL. For example, the sensing driver 600 may sense a first to N-th pixels in response to the power-off signal OFFS, where N is a positive integer. For example, in a blank period, the sensing driver 600 may sense at least one of the pixels PX. For example, the sensing driver 600 may sense a driving characteristic (e.g., a mobility and/or a threshold voltage) of the driving transistor by measuring a sensing current (or a sensing voltage) of the driving transistor of the pixels PX through the sensing lines SL. For example, an operation sensing the driving characteristic (e.g., a mobility and/or a threshold voltage) of the driving transistor may be called a sensing operation. For example, the sensing data SD may include first to N-th sensing data corresponding to the first to N-th pixels.

In an embodiment of the present inventive concept, the sensing driver 600 may be implemented with one or more integrated circuits. In an embodiment of the present inventive concept, the sensing driver 600 may be included in the data driver 500 or the driving controller 200.

In an embodiment of the present inventive concept, the sensing driver 600 may be integrated on the peripheral region of the display panel 100. In an embodiment of the present inventive concept, the sensing driver 600 may be mounted on the peripheral region of the display panel 100.

The non-volatile memory circuit 700 may store stored sensing data as stored compensation data. For example, the non-volatile memory circuit 700 may be formed as flash memory. However, the present inventive concept is not limited to a type of the non-volatile memory circuit.

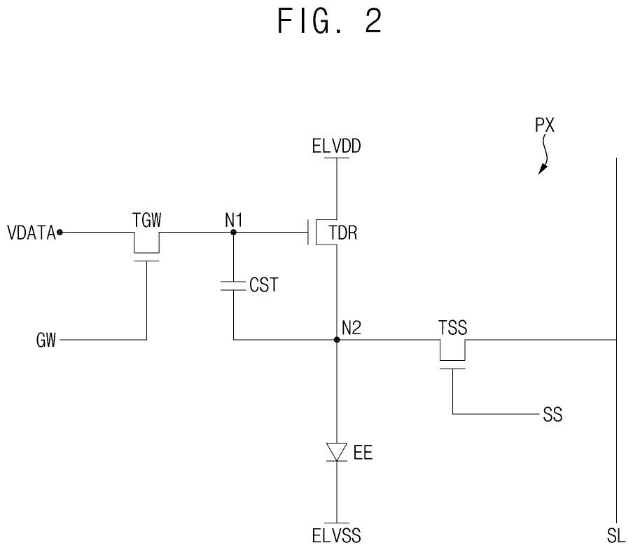

FIG. 2 is a circuit diagram illustrating a pixel PX of FIG. 1.

Referring to FIG. 1 and FIG. 2, the pixel PX may include a driving transistor TDR, a writing transistor TGW, a sensing transistor TSS, a storage capacitor CST and a light emitting element EE. For example, the pixel PX may have a 3T1C structure. Additionally, although FIG. 2 is illustrated that the transistors of pixel PX of FIG. 2 are an N-type transistor, the present inventive concept is not limited to a type of transistors included in the pixel PX. For example, the transistors of the pixel PX may be a P-type transistor.

The driving transistor TDR may include a control electrode connected to a first node N1, a first electrode receiving a first power voltage ELVDD and a second electrode connected to a second node N2. In the present embodiment, the driving transistor TDR may supply the sensing current to the second node N2 in response to a voltage of the first node N1.

The writing transistor TGW may include a control electrode receiving a writing gate signal GW, a first electrode receiving the data voltage VDATA and a second electrode connected to the first node N1. The writing transistor TGW may supply the data voltage VDATA to the first node N1 in response to the writing gate signal GW.

The sensing transistor TSS may include a control electrode receiving a sensing signal SS, a first electrode connected to a sensing line SL and a second electrode connected to a second node N2. The sensing transistor TSS may supply the sensing current to the sensing line SL in response to the sensing signal SS.

The storage capacitor CST may include a first electrode connected to the first node N1 and the second electrode connected to the second node N2.

The light emitting element EE may include an anode connected to the second node N2 and a cathode receiving a second power voltage ELVSS.

In the present embodiment, the sensing operation may be performed in response to the power-off signal OFFS. In an embodiment, the sensing operation may be performed to at least one pixel of pixels PX.

Additionally, although FIG. 2 is illustrated that the transistors of pixel PX of FIG. 2 are an N-type transistor, the present inventive concept is not limited to a type of transistors included in the pixel PX. For example, the transistors of the pixel PX may be a P-type transistor.

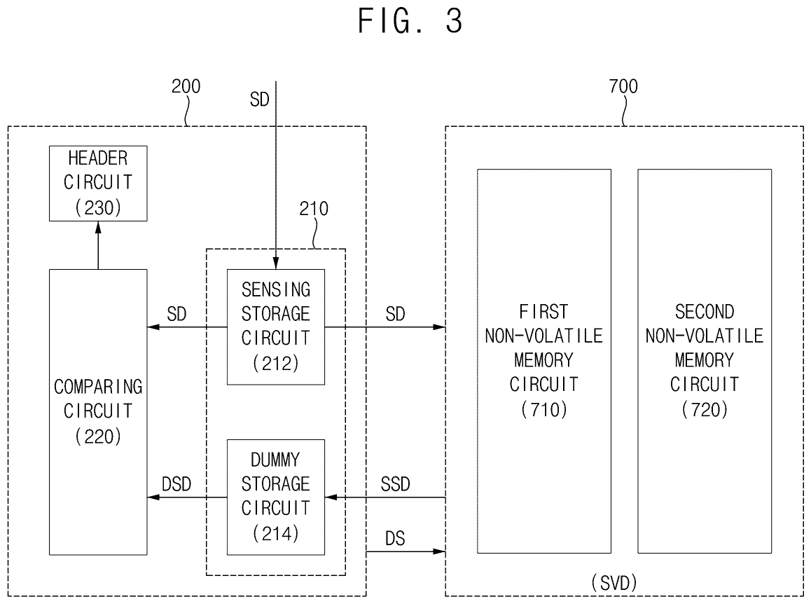

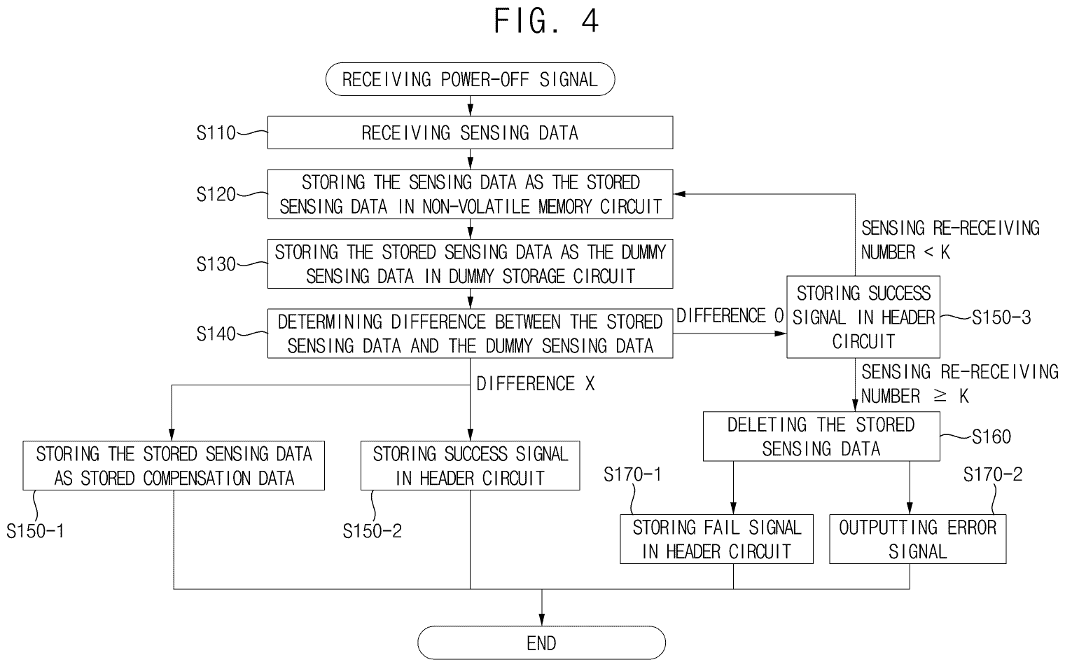

FIG. 3 is a block diagram illustrating a driving controller 200 and a non-volatile memory circuit 700 included in a display device of FIG. 1. FIG. 4 is a flowchart illustrating an operation that a display device of FIG. 1 stores a stored compensation data SVD.

Referring to FIG. 1 to FIG. 4, in the present embodiment, the driving controller 200 may include a temporary storage circuit 210, a comparing circuit 220 and a header circuit 230. The non-volatile memory 700 may include a first non-volatile memory 710 and a second non-volatile memory 720. The temporary storage circuit 210 may include a sensing storage circuit 212 and a dummy storage circuit 214.

In the present embodiment, the sensing storage circuit 212 may receive and store the sensing data SD. The sensing storage circuit 212 may be a volatile memory. For example, the volatile memory may be Dynamic Random Access Memory (DRAM), Static Random Access Memory (SRAM), etc. However, the present inventive concept is not limited to a type of the memory. The sensing storage circuit 212 may temporarily store the sensing data SD received from the sensing driver 600. The sensing data SD stored in the sensing storage circuit 212 may be stored sensing data SSD. For example, the non-volatile memory circuit 700 may store first to N-th stored sensing data corresponding to the first to N-th sensing data.

In the present embodiment, the dummy storage circuit 214 may receive the stored sensing data SSD from the non-volatile memory circuit 700. The dummy storage circuit 214 may store the stored sensing data SSD received from the non-volatile memory circuit 700 as dummy sensing data DSD. The dummy storage circuit 214 may be a volatile memory. For example, the volatile memory may be Dynamic Random Access Memory (DRAM), Static Random Access Memory (SRAM), etc. However, the present inventive concept is not limited to a type of the memory. The dummy storage circuit 214 may temporarily store the stored sensing data SSD received from the non-volatile memory circuit 700 as dummy sensing data DSD. For example, the dummy storage circuit 214 may store first to N-th dummy sensing data corresponding to the first to N-th stored sensing data.

In the present embodiment, the comparing circuit 220 may compare the sensing data SD received from the sensing storage circuit 212 with the dummy sensing data DSD received from the dummy storage circuit 214. The comparing circuit 220 may determine a difference between the sensing data SD and the dummy sensing data DSD. In an embodiment, the comparing circuit 220 may compare the stored sensing data SSD with the sensing data SD. Comparing the stored sensing data SSD with the sensing data SD may be performed by determining whether values obtained by subtracting the sensing data SD from the stored sensing data SSD are 0.

For example, when the sensing data SD and the dummy sensing data have 8-bits binary code, a process of comparing the stored sensing data SSD with the sensing data SD may be performed by determining whether values obtained by subtracting each bits of the sensing data SD from each bits of the stored sensing data SSD are 0. In an embodiment, a process of comparing the stored sensing data SSD with the sensing data SD is performed by determining whether values obtained by subtracting the first sensing data from the first stored sensing data to values obtained by subtracting the N-th sensing data from the N-th stored sensing data are all 0.

In a conventional display device, an error occurring in a memory of the conventional display device may be determined by using a check-sum method. The check-sum method may refer to a method of determining an error by accumulating values stored in the memory and performing an exclusive OR (XOR) operation.

A process of determining an error of the display device according to the present inventive concept may be performed by determining whether values obtained by subtracting each bits of the sensing data SD from each bits of the stored sensing data SSD are 0. Accordingly, a calculating speed of the process of determining an error of the display device according to the present inventive concept may be improved compared with the check-sum method. Additionally, a reliability of calculating may be improved.

In the present embodiment, when the sensing data SD and the dummy sensing data DSD are different (i.e., at least one value obtained by subtracting each bits of the sensing data SD from each bits of the stored sensing data SSD is not 0), the comparing circuit 220 may output a fail signal to the header circuit 230.

In the present embodiment, when the sensing data SD and the dummy sensing data DSD are same (i.e., all of values obtained by subtracting each bits of the sensing data SD from each bits of the stored sensing data SSD are 0), the comparing circuit 220 may output a success signal to the header circuit 230. For example, when the sensing data SD and dummy sensing data DSD are same, the stored sensing data SSD may not have an error. For example, when the sensing data SD and dummy sensing data DSD are different, the stored sensing data SSD may have the error.

In the present embodiment, the header circuit 230 may receive the fail signal or the success signal from the comparing circuit 220. The header circuit 230 may store the fail signal and the success signal.

The success signal may mean that the stores sensing data SSD of the display device may not have the error. The fail signal may mean that the stored sensing data SSD of the display device may have the error. The driving controller 200 may determine the error of the stored sensing data SSD through the success signal and the fail signal.

In the present embodiment, the non-volatile memory circuit 700 may include a first non-volatile memory circuit 710 and a second non-volatile memory circuit 720. For example, the first non-volatile memory circuit 710 and the second non-volatile memory circuit 720 may be a flash memory. However, the present inventive concept is not limited to a type of the flash memory.

In the present embodiment, the sensing data SD may be alternately applied to the first non-volatile memory circuit 710 and the second non-volatile memory circuit 720. The sensing operation may be performed in response to a first power-off signal. Accordingly, a first stored compensation data corresponding to the first power-off signal may be stored in the first non-volatile memory circuit 710. For example, the first stored compensation data may be called as a previous stored compensation data. For example, the sensing operation may be performed in response to a second power-off signal after the first power-off signal. Accordingly, a second stored compensation data corresponding to the second power-off signal may be stored in the second non-volatile memory circuit 720. For example, the sensing operation may be performed in response to a third power-off signal after the second power-off signal. Accordingly, a third stored compensation data corresponding to the third power-off signal may be stored in the first non-volatile memory circuit 710.

In the present embodiment, when the sensing data SD and the dummy sensing data DSD are same (i.e., values obtained by subtracting the sensing data SD from the dummy sensing data DSD are 0), the non-volatile memory circuit 700 may store the stored sensing data SSD as stored compensation data SVD. In the present embodiment, the dummy sensing data DSD may be synchronized with the sensing data SD. In the present embodiment, the stored sensing data SSD may be synchronized with the sensing data SD. For example, the stored sensing data SSD may be same with the sensing data SD.

In the present embodiment, when the sensing data SD and the dummy sensing data DSD are different (i.e., values obtained by subtracting the sensing data SD from the dummy sensing data DSD are not 0), the non-volatile memory circuit 700 may re-receive the sensing data SD from the sensing storage circuit 212. For example, an operation which the non-volatile memory circuit 700 re-receives the sensing data SD from the sensing storage circuit 212 may be called as a sensing re-receiving operation. Additionally, a number of performing the sensing re-receiving operation may be called as a sensing re-receiving number. The non-volatile memory circuit 700 may store the re-received sensing data as re-received sensing data. Additionally, the dummy storage circuit 214 may receive the re-received sensing data from the non-volatile memory circuit 700. The dummy storage circuit 214 may store the re-received sensing data receiving from the non-volatile memory circuit 700 as re-received dummy sensing data. The comparing circuit 220 may compare the sensing data SD with the re-received dummy sensing data.

When the sensing data SD and the re-received dummy sensing data are same, the non-volatile memory circuit 700 may store the re-received dummy sensing data as the stored compensation data SVD.

When the sensing data SD and the re-received dummy sensing data are different and the sensing re-receiving number is more than a reference sensing number K of times, where K is a positive integer, the stored sensing data SSD may be deleted. For example, the stored sensing data SSD may be deleted in response to a delete signal DS. For example, when the stored sensing data SSD is deleted, it is determined that the stored sensing data SSD may have an error. The reference sensing number K may be set by user. For example, the reference sensing number K may be changed by user. Additionally, the fail signal may be stored in the header circuit 230. Additionally, the panel driver may output an error signal. For example, the error signal may be applied to an external device. For example, the external device may be a host processor (e.g., application processor) and/or graphic processing unit (GPU). However, the present inventive concept is not limited to a type of the external device.

In the conventional display device, compensation data may not be stored uniformly in a non-volatile memory. For example, in the conventional display device, some of the compensation data may be missing. Additionally, the compensation data may be mis-stored in the non-volatile memory. Accordingly, dark spot and dark line may be visible in a display panel of the conventional display device.

The display device according to the present inventive concept may include dummy storage circuit 214 which stores the dummy sensing data DSD. Additionally, the display device may determine a difference between the sensing data SD and the dummy sensing data DSD, and store the stored compensation data SVD in the non-volatile memory circuit 700. Accordingly, an error of the stored compensation data SVD stored in the non-volatile memory circuit 700 may be reduced. Additionally, by reducing the error, a visibility of the dark spot and dark may be reduced.

The power-off signal OFFS may be applied to the panel driver. The sensing operation may be performed in response to the power-off signal OFFS. The sensing data SD may be received in response to the sensing operation. (S110) The sensing data SD may be stored as the stored sensing data SSD in the non-volatile memory circuit 700. (S120) The stored sensing data SSD may be stored as the dummy sensing data DSD in the dummy storage circuit 214. (S130) A difference between the stored sensing data SSD and the dummy sensing data DSD may be determined. (S140) When the dummy sensing data and the stored sensing data are same, the stored sensing data SSD may be stored as stored compensation data SVD (S150-1) and the success signal may be stored in the header circuit 230 (S150-2). When the dummy sensing data and the stored sensing data are different, the sensing re-receiving number may be determined. (S150-3) When the sensing re-receiving number is less than a reference sensing number, the sensing re-receiving operation may be performed. When the sensing re-receiving number is more than or equal to a reference sensing number, the stored sensing data SSD may be deleted. (S160) Additionally, the fail signal may be stored in the header circuit 230 (S170-1) and the panel driver may output the error signal (S170-2).

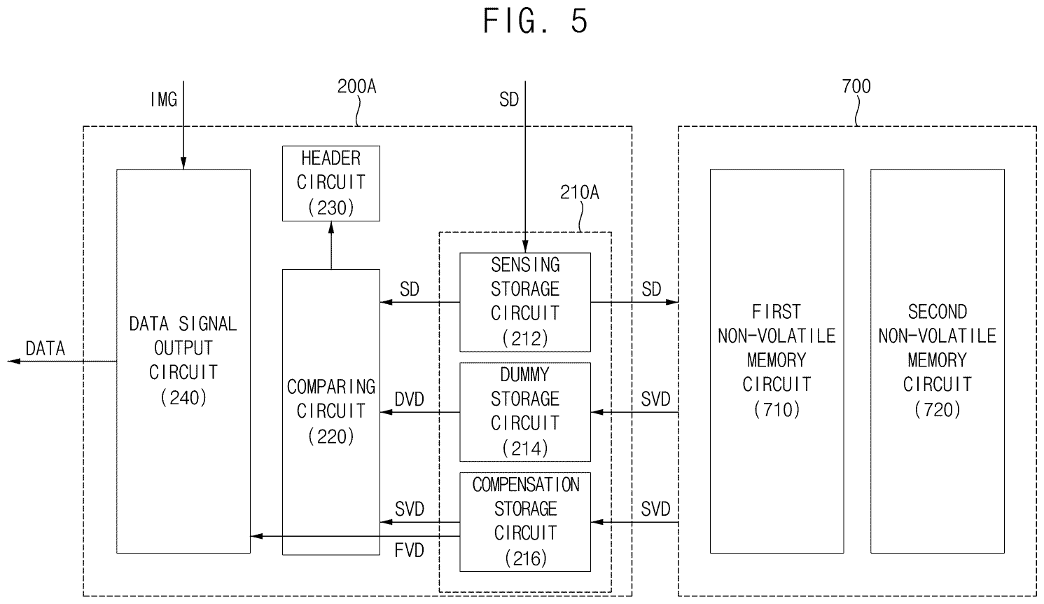

FIG. 5 is a block diagram illustrating the driving controller 200A and the non-volatile memory circuit 700 included in the display device of FIG. 1.

Referring to FIG. 5, in the present embodiment, the driving controller 200A may include a temporary storage circuit 210A, the comparing circuit 220, the header circuit 230 and the data signal output circuit 240. The temporary storage circuit 210A may include the sensing storage circuit 212, the dummy storage circuit 214 and a compensation storage circuit 216.

In the present embodiment, the dummy storage circuit 214 may receive the stored compensation data SVD from the non-volatile memory circuit 700. The dummy storage circuit 214 may temporarily store the stored compensation data SVD. The dummy storage circuit 214 may store the stored compensation data SVD as dummy compensation data DVD. The compensation storage circuit 216 may receive the stored compensation data SVD from the non-volatile memory circuit 700. The comparing circuit 220 may receive the dummy compensation data DVD from the dummy storage circuit 214. The comparing circuit 220 may receive the stored compensation data SVD from the compensation storage circuit 216. The comparing circuit 220 may compare the dummy compensation data DVD with stored compensation data SVD. The comparing circuit 220 may determine a difference between the dummy compensation data DVD and the stored compensation data SVD. In an embodiment, a process of comparing the dummy compensation data DVD and the stored compensation data SVD may be performed by determining that values obtained by subtracting the dummy compensation data DVD from the stored compensation data SVD are 0.

For example, when the stored compensation data SVD and the dummy compensation data DVD have 8-bits binary code, a process of comparing the dummy compensation data DSD with the stored compensation data SVD may be performed by determining whether values obtained by subtracting each bits of the dummy compensation data DVD from each bits of the stored compensation data SVD are 0. In an embodiment, a process of comparing the stored compensation data SVD with the dummy sensing data DSD is performed by determining whether values obtained by subtracting the first dummy compensation data from the first stored compensation data to values obtained by subtracting the N-th dummy compensation data from the N-th stored compensation data are all 0.

In the present embodiment, when the dummy compensation data DVD and the stored compensation data SVD are same, the compensation storage circuit 216 may output the stored compensation data SVD as final compensation data FVD to the data signal output circuit 240. The data signal output circuit 240 may output the data signal DATA based on the input image data IMG and the final compensation data FVD. The header circuit 230 may store the success signal.

In the present embodiment, when the dummy compensation data DVD and the stored compensation data SVD are different, the compensation storage circuit 216 and the dummy storage circuit 214 may re-receive the stored compensation data SVD from the non-volatile memory 700. For example, an operation which the compensation storage circuit 216 and the dummy storage circuit 214 re-receive the stored compensation data SVD from the non-volatile memory circuit 700 may be called as a compensation re-receiving operation. Additionally, a number of performing the compensation re-receiving operation may be called as a compensation re-receiving number. The dummy storage circuit 214 may store the re-received stored compensation data as re-received dummy compensation data. Additionally, the compensation storage circuit 216 may store the re-received stored compensation data from the non-volatile memory circuit 700 as re-received stored compensation data. The comparing circuit 220 may compare the re-received stored compensation data with the re-received dummy compensation data.

When the re-received compensation data and the re-received dummy compensation data are same, the compensation storage circuit 216 may output the re-received compensation data as the final compensation data FVD to the data signal output circuit 240. The header circuit 230 may store the success signal.

When the re-received compensation data and the re-received dummy compensation data are different and the compensation re-receiving number is more than or equal to a reference compensation number M of times, where M is a positive integer, the panel driver may output the error signal to the external device. The reference compensation number M may be set by user. For example, the reference compensation number M may be changed by user. Additionally, the fail signal may be stored in the header circuit 230. Additionally, when the re-received compensation data and the re-received dummy compensation data are different, the data signal output circuit 240 may output the data signal DATA based on the input image data IMG and the previous stored compensation data.

In the present embodiment, the stored compensation data SVD may be synchronized with the dummy compensation data DVD.

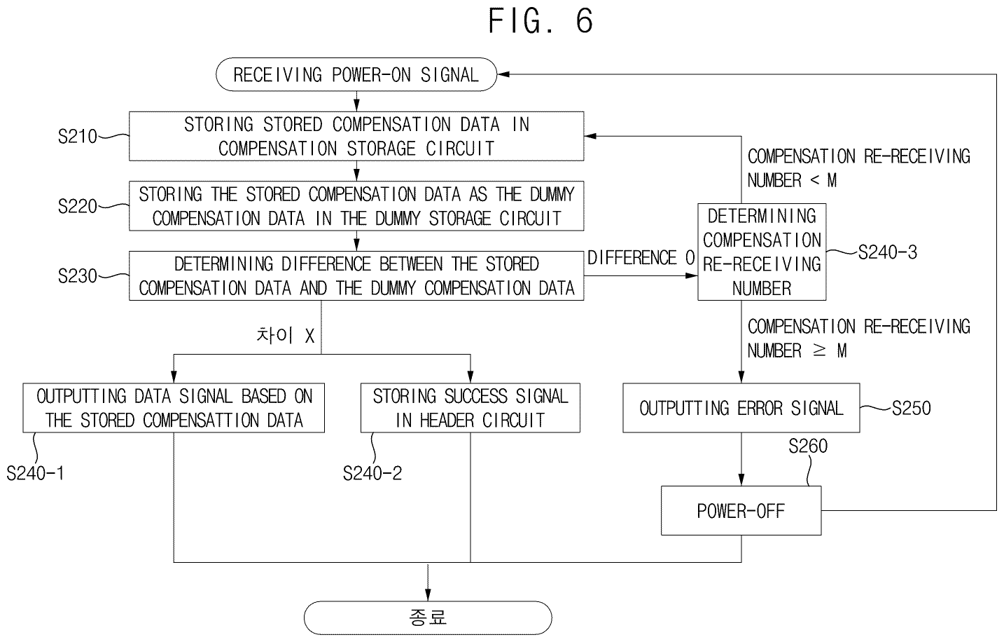

FIG. 6 is a flowchart illustrating an operation of generating a data signal DATA from a display device of FIG. 1.

Referring to FIG. 1, FIG. 5 and FIG. 6, in the present embodiment, an operation of generating the data signal DATA may be performed by following sequence.

The power-on signal ONS may be applied to the panel driver. The stored compensation data SVD may be stored in the compensation storage circuit 216. (S210) The stored compensation data SVD may be stored as dummy compensation data DVD in the dummy storage circuit 214. (S220) A difference between the dummy compensation data DVD and the stored compensation data SVD may be determined. (S230) When the dummy compensation data DVD and stored compensation data SVD are same, data signal DATA may be outputted based on the stored compensation data SVD (S240-1) and the success signal may be stored in the header circuit 230. (S240-2)

When the dummy compensation data DVD and the stored compensation data SVD are different, the compensation re-receiving number may be determined. (S240-3) When the compensation re-receiving number is less than the reference compensation number M, the compensation re-receiving operation may be performed. When the compensation re-receiving number is more than or equal to the reference compensation number, the panel driver may output the error signal. (S250) Additionally, the panel driver may be turned-off (S260) and then turned-on. Accordingly, the panel driver may generate the data signal DATA based on the previous stored compensation data.

In an embodiment, when the compensation re-receiving number is more than or equal to the reference compensation number, the sensing operation may be performed. For example, when the compensation re-receiving number is more than or equal to the reference compensation number in the first non-volatile memory circuit 710, in response to a power-off operation, the stored sensing data SSD may be stored in the second non-volatile memory circuit 720. After, in response to a power-on operation, the data signal DATA may be generated based on the stored compensation data SVD of the second non-volatile memory circuit 720.

The driving controller 200A may include the dummy storage circuit 214 storing the dummy compensation data DVD. Accordingly, the driving controller 200A may determine the final compensation data FVD by comparing the stored compensation data SVD with the dummy compensation data DVD. The driving controller 200A may output the data signal DATA based on the final compensation data FVD. Accordingly, an error between the stored compensation data SVD stored in the non-volatile memory circuit 700 and the final compensation data FVD may be reduced. Additionally, the error between the stored compensation data SVD and the final compensation data FVD may be reduced, so that the visibility of dark line and the dark point may be reduced.

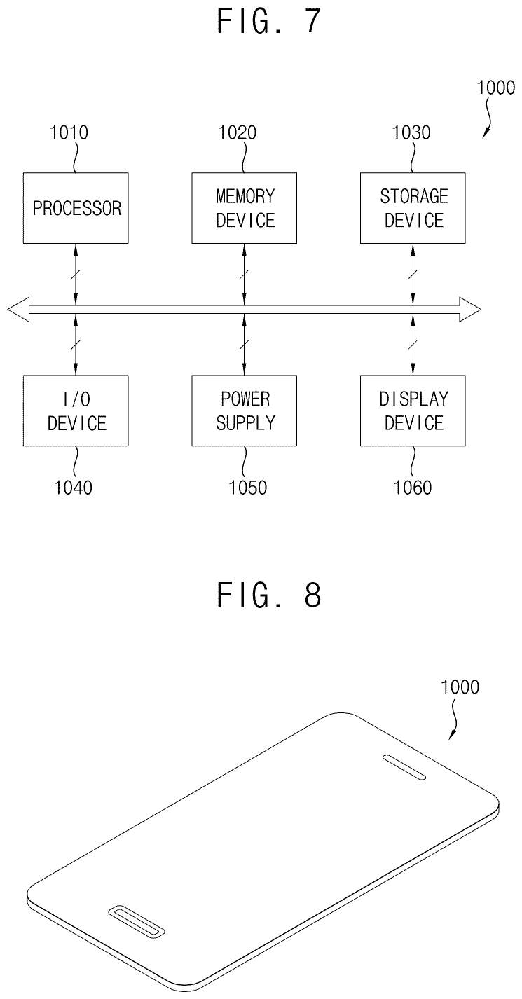

FIG. 7 is a block diagram illustrating an electronic device according to an embodiment of the present inventive concept. FIG. 8 is a diagram illustrating an example in which the electronic device of FIG. 7 is implemented as a smart phone.

Referring to FIGS. 7 and 8, the electronic device 1000 may include a processor 1010, a memory device 1020, a storage device 1030, an input/output (I/O) device 1040, a power supply 1050, and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic device, etc.

In an embodiment, as illustrated in FIG. 8, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal APPON and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

The display device according to the embodiments may be applied to a display device included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A display device comprising:
a display panel including a plurality of pixels;
a data driver configured to apply data voltages to the plurality of pixels based on a data signal;
a sensing driver configured to receive sensing current from at least one pixel of the plurality of pixels and to output sensing data based on the sensing current;
a non-volatile memory circuit configured to store the sensing data as stored sensing data; and
a driving controller configured to output the data signal to the data driver and to store the sensing data received from the sensing driver,
wherein the driving controller is configured to determine a difference between the stored sensing data and the sensing data by comparing the stored sensing data with the sensing data, and
wherein the non-volatile memory circuit is configured to store the stored sensing data which is the same as the sensing data as stored compensation data.

2. The display device of claim 1, wherein the driving controller compares the stored sensing data with the sensing data by determining whether values obtained by subtracting the sensing data from the stored sensing data are 0.

3. The display device of claim 1, wherein the driving controller includes:
a sensing storage circuit configured to store the sensing data;
a dummy storage circuit configured to store the stored sensing data received from the non-volatile memory circuit as dummy sensing data;
a comparing circuit configured to compare the dummy sensing data with the sensing data; and
a header circuit configured to store a success signal and a fail signal from the comparing circuit.

4. The display device of claim 3, wherein, when a difference between the dummy sensing data and the sensing data is 0, the comparing circuit outputs the success signal to the header circuit and the non-volatile memory circuit stores the stored sensing data as the stored compensation data.

5. The display device of claim 4, wherein the pixels include a first pixel and a second pixel,
wherein the sensing data include first sensing data corresponding to the first pixel and second sensing data corresponding to the second pixel,
wherein the stored sensing data include first stored sensing data corresponding to the first sensing data and second stored sensing data corresponding to the second sensing data,
wherein the dummy sensing data include first dummy sensing data corresponding to the first stored sensing data and second dummy sensing data corresponding to the second stored sensing data, and
wherein the driving controller compares the stored sensing data with the sensing data by determining whether values obtained by subtracting the first sensing data from the first stored sensing data and values obtained by subtracting the second sensing data from the second stored sensing data are both 0.

6. The display device of claim 3, wherein when a difference between the dummy sensing data and the sensing data is not 0, the comparing circuit outputs the fail signal to the header circuit and the dummy storage circuit receives the stored sensing data again.

7. The display device of claim 6, wherein when a difference between re-stored sensing data which the dummy storage circuit receives again and the sensing data is 0, the comparing circuit outputs the success signal to the header circuit and the non-volatile memory circuit stores the re-stored sensing data as the stored compensation data.

8. The display device of claim 6, wherein, when the dummy storage circuit receives the stored sensing data more than or equal to a reference sensing number of times, the driving controller outputs an error signal.

9. The display device of claim 6, wherein the non-volatile memory circuit includes a first non-volatile memory circuit and a second non-volatile memory circuit,
wherein the stored sensing data is applied to the dummy storage circuit from the first non-volatile memory circuit, and
wherein, when the dummy storage circuit receives the stored sensing data more than or equal to a reference sensing number of times, the stored sensing data stored in the first non-volatile memory circuit are deleted.

10. The display device of claim 3, wherein the driving controller further includes:
a compensation storage circuit configured to receive the stored compensation data from the non-volatile memory circuit; and
a data signal output circuit configured to output the data signal,
wherein the dummy storage circuit is configured to store dummy compensation data by receiving the stored compensation data from the non-volatile memory circuit,
wherein the comparing circuit is configured to compare the dummy compensation data with the stored compensation data stored in the compensation storage circuit, and
wherein when the dummy compensation data are consistent with the stored compensation data stored in the compensation storage circuit, the data signal output circuit outputs the data signal based on the stored compensation data.

11. The display device of claim 10, wherein when the dummy compensation data are consistent with the stored compensation data stored in the compensation storage circuit, the comparing circuit outputs the success signal to the header circuit.

12. The display device of claim 3, wherein the driving controller further includes:
a compensation storage circuit configured to receive the stored compensation data from the non-volatile memory circuit; and
a data signal output circuit configured to output the data signal,
wherein the non-volatile memory circuit includes a first non-volatile memory circuit and a second non-volatile memory circuit,
wherein the compensation storage circuit receives the stored compensation data from the first non-volatile memory circuit,
wherein the dummy storage circuit receives the stored compensation data from the first non-volatile memory circuit and stores the stored compensation data as dummy compensation data,
wherein the comparing circuit is configured to compare the dummy compensation data with the stored compensation data stored in the compensation storage circuit, and
wherein, when the dummy compensation data are inconsistent with the stored compensation data stored in the compensation storage circuit, the dummy storage circuit and the compensation storage circuit receives the stored compensation data again.

13. The display device of claim 12, wherein, when the dummy compensation data are inconsistent with the stored compensation data stored in the compensation storage circuit, the comparing circuit outputs the fail signal to the header circuit.

14. The display device of claim 12, wherein, when the dummy storage circuit receives the stored sensing data more than or equal to a reference sensing number of times, the data signal output circuit outputs the data signal based on second storage compensation data stored in the second non-volatile memory circuit.

15. A display device comprising:
a display panel including a plurality of pixels;
a data driver configured to apply data voltages to the plurality of pixels based on a data signal;
a sensing driver configured to receive sensing current from at least one pixel of the plurality of pixels and to output sensing data based on the sensing current;
a non-volatile memory circuit configured to store the sensing data as stored sensing data; and
a driving controller configured to output the data signal to the data driver and to store the sensing data received from the sensing driver,
wherein the driving controller includes:
a dummy storage circuit configured to store the stored compensation data received from the non-volatile memory circuit as dummy compensation data;
a compensation storage circuit configured to receive the stored compensation data from the non-volatile memory circuit; and
a data signal output circuit configured to output the data signal, and
wherein the driving controller is configured to output the data signal based on the stored compensation data when the stored compensation data and the dummy compensation data are same.

16. The display device of claim 15, wherein the driving controller compares the stored sensing data with the sensing data by determining whether values obtained by subtracting the sensing data from the stored sensing data are 0.

17. The display device of claim 15, wherein when the dummy compensation data and the stored compensation data stored in the compensation storage circuit are different, the dummy storage circuit and the compensation storage circuit receive the stored compensation data again.

18. The display device of claim 15, wherein the non-volatile memory circuit includes a first non-volatile memory circuit and a second non-volatile memory circuit,
wherein the compensation storage circuit is configured to receive the stored compensation data from the first non-volatile memory circuit,
wherein the dummy storage circuit is configured to store dummy compensation data which is the stored compensation data received from the first non-volatile memory circuit, and
wherein, when the dummy storage circuit receives the stored sensing data more than or equal to a reference sensing number of times, the data signal output circuit outputs the data signal based on second storage compensation data stored in the second non-volatile memory circuit.

19. A method of driving a display device, the method comprising:
receiving sensing data;
storing the sensing data as stored sensing data in a non-volatile memory circuit;
storing the sensing data as dummy sensing data in a dummy storage circuit;
comparing the dummy sensing data with the stored sensing data;
performing a deleting operation of the stored sensing data, a storing operation of a fail signal, and an outputting operation of an error signal when the dummy sensing data are inconsistent with the stored sensing data; and
storing the stored sensing data as stored compensation data in the non-volatile memory circuit when the dummy sensing data and the stored sensing data are same,
wherein comparison between the stored sensing data and the dummy sensing data is performed by determining whether values obtained by subtracting the sensing data from the stored sensing data are 0.

20. The method of claim 19, further comprising:
storing the stored compensation data as dummy compensation data in the dummy storage circuit;
comparing the stored compensation data with the dummy compensation data;
outputting a data signal based on previous stored compensation data, storing the fail signal and outputting the error signal when the dummy compensation data are inconsistent with the stored compensation data; and
outputting the data signal based on the stored compensation data when the dummy compensation data are consistent with the stored compensation data.
